(19) United States
(12) Patent Application Publication
(10) Pub. No.: US 2015/0148935 A1
(43) Pub. Date: May 28, 2015

(54) SUBSTRATE PROCESSING SYSTEM, SUBSTRATE PROCESSING APPARATUS, DATA PROCESSING METHOD, AND STORAGE MEDIUM

(71) Applicant: Hitachi Kokusai Electric Inc., Tokyo (JP)

(72) Inventor: Toshiro Koshimaki, Toyama-shi (JP)

(73) Assignee: Hitachi Kokusai Electric Inc., Tokyo (JP)

(21) Appl. No.: 14/408,164

(22) PCT Filed: Jun. 21, 2013
(86) PCT No.: PCT/JP2013/067098

§ 371 Date: Dec. 15, 2014

(30) Foreign Application Priority Data
Jul. 4, 2012 (JP) 2012-150285

(51) Int. Cl. G05B 19/418

(52) U.S. Cl. CPC G05B 19/418; G05B 2219/2602
USPC 700/121

(57) ABSTRACT

A substrate processing system includes a substrate processing apparatus for generating apparatus data on substrate processing and a management apparatus connected to at least one substrate processing apparatus via a network for receiving and storing the apparatus data periodically reported from the substrate processing apparatus. The substrate processing apparatus includes a storage unit for storing the apparatus data a report cycle or the number of reports of the apparatus data to the management apparatus, and a degree of importance of the apparatus data in association with a data type of the apparatus data, and a control unit for, when changing a report cycle of the apparatus data, determining a data type of the report cycle of which is to be changed based on the report cycle or the number of reports and the degree of importance per data type stored in the storage unit.

### CROSS-REFERENCE TO RELATED PATENT APPLICATION

This application is a continuation of International Application No. PCT/JP2013/067098 filed on Jun. 21, 2013 which claims priority under 35 U.S.C. 119 to Japanese Application No. 2012-150285 filed on Jul. 4, 2012, the entire contents of which are hereby incorporated by reference.

### TECHNICAL FIELD OF THE INVENTION

The present invention relates to a substrate processing apparatus for processing a substrate such as semiconductor wafer and outputting various items of apparatus data including monitored data such as processing temperature and processing chamber inside pressure, a higher apparatus for collecting and accumulating various items of apparatus data output from the substrate processing apparatus, a substrate processing system configured of the substrate processing apparatus and the higher apparatus, and a data processing method in the substrate processing system.

### DESCRIPTION OF THE RELATED ART

For example, a substrate processing apparatus functioning as a semiconductor device manufacturing apparatus (semiconductor manufacturing apparatus) stores therein various items of apparatus data including monitored data such as processing temperature and processing chamber inside pressure caused in the substrate processing apparatus, and periodically transmits and reports the same to a collective management apparatus as a higher apparatus via a network such as in-plant LAN. The collective management apparatus stores various items of apparatus data received from a plurality of substrate processing apparatuses in a database in the collective management apparatus. The stored apparatus data is used for a uniform film forming processing between the substrate processing apparatuses which perform the same processings, or failure analysis on failure occurrence, for example.

A cycle in which the apparatus data stored in the substrate processing apparatus is reported to the collective management apparatus is received and acquired from the collective management apparatus when the substrate processing apparatus is powered on and is communicated with the collective management apparatus. The substrate processing apparatus transmits its storing apparatus data to the collective management apparatus at a fixed report cycle acquired from the collective management apparatus. The apparatus data to be transmitted to the collective management apparatus includes process monitored data such as processing temperature, processing chamber inside pressure, gas flow rate and various items of sensor information, or mechanical monitored data such as position of a drive shaft operating in substrate transfer.

In recent years, the amount of data to be reported from the substrate processing apparatus to the collective management apparatus is increasing along with an increase in types of apparatus data reported due to higher functions of the substrate processing apparatus, and a refinement in apparatus data granularity (shorter report cycle) reported on demand from a user of the substrate processing apparatus. For example, when an abnormality occurs in the substrate processing apparatus, a large amount of apparatus data on the abnormality is reported in order to investigate the abnormality causes. Reports from many substrate processing apparatus connected to a network may concentrate at a timing.

Therefore, when all the apparatus data stored in the substrate processing apparatuses is reported to the collective management apparatus at a fixed cycle as conventionally, a large amount of data is reported, and thus all the apparatus data cannot be stored in the database in the collective management apparatus, which may cause a database overflow. Then, a communication overload state on the network occurs due to the database overflow, and the operation of the substrate processing apparatus may stop at worst. Further, when reports from many substrate processing apparatuses connected to the network concentrate, if the substrate processing apparatuses report the apparatus data to the collective management apparatus at a fixed cycle, a communication overload state on the network occurs, and similarly the operation of the substrate processing apparatuses may stop.

The following Patent Literature 1 discloses that a report cycle to report from a substrate processing apparatus to a collective management apparatus is changed depending on an operation status (normal time, emergency time, recipe execution time, or adjustment time) of the substrate processing apparatus.

### CITATION LIST

### Patent Literature

### Patent Literature 1: JP 2005-276935 A

### SUMMARY OF INVENTION

With the technique in the above Patent Literature 1, however, a report cycle to the collective management apparatus is fixed depending on an operation status of the substrate processing apparatus, and an increase in apparatus data in an operation status such as recipe execution cannot be sufficiently addressed. It is an object of the present invention to adjust the amount of apparatus data to be transmitted to the collective management apparatus thereby to restrict adverse impacts on the collective management apparatus along with an increase in data between the substrate processing apparatus and the collective management apparatus.

According to one aspect of the present invention, there is provided a substrate processing system including a substrate processing apparatus for generating apparatus data on a substrate processing, and a management apparatus connected to at least one substrate processing apparatus via a network and for receiving and storing the apparatus data periodically reported from the substrate processing apparatus, wherein the substrate processing apparatus includes a storage unit for storing the apparatus data generated inside the substrate processing apparatus, a report cycle or the number of reports of the apparatus data to the management apparatus, and a degree of importance of the apparatus data in association with a data type of the apparatus data, and a control unit for, when changing a report cycle of the apparatus data, determining a data type of the report cycle of which is to be changed based on the report cycle or the number of reports and the degree of importance per data type stored in the storage unit.

According to another aspect of the present invention, there is provided a substrate processing apparatus for generating and periodically reporting apparatus data on a substrate processing, the apparatus including a storage unit for storing the apparatus data generated inside the substrate processing apparatus, a report cycle or the number of reports of the apparatus data, and a degree of importance of the apparatus data in association with a data type of the apparatus data, and a control unit for, when changing a report cycle of the apparatus data, determining a data type of the report cycle of which is to be changed based on the report cycle or the number of reports and the degree of importance per data type stored in the storage unit.

According to still another aspect of the present invention, there is provided a data processing method in a substrate processing apparatus including a storage unit for storing at least apparatus data on a substrate processing, and a control unit for periodically reporting the apparatus data, wherein the control unit performs a step of collecting the apparatus data, a step of storing the collected apparatus data, a report cycle or the number of reports of the apparatus data, and a degree of importance of the apparatus data in association with a data type of the apparatus data, and a data type determination step of, when changing a report cycle of the apparatus data, determining a data type of the report cycle of which is to be changed based on the report cycle or the number of reports and the degree of importance stored per data type.

According to still another aspect of the present invention, there is provided a storage medium capable of reading a data report program to perform a processing of reporting apparatus data on a substrate processing to a management apparatus, a processing of storing the apparatus data, a report cycle or the number of reports of the apparatus data to the management apparatus, and a degree of importance of the apparatus data in association with a data type of the apparatus data, and a data type determination processing of, when changing a report cycle of the apparatus data, determining a data type of the report cycle of which is to be changed based on the report cycle or the number of reports and the degree of importance stored per data type.

With the above structure, it is possible to prevent a communication overload state from occurring in the collective management apparatus even if the amount of apparatus data generated in the substrate processing apparatus increases in an operation status.

### BRIEF DESCRIPTION OF DRAWINGS

FIG. 1 illustrates exemplary structures of a substrate processing system according to a first embodiment of the present invention, a substrate processing apparatus and a collective management apparatus.

FIG. 2 is a perspective view illustrating an entire structure of the substrate processing apparatus according to the first embodiment of the present invention.

FIG. 3 is a vertical cross-section view of the substrate processing apparatus according to the first embodiment of the present invention.

FIG. 4 is an updated data storage table according to the first embodiment of the present invention.

FIG. 5 is a data update information storage table according to the first embodiment of the present invention.

FIG. 6 is a report cycle switch setting table according to the first embodiment of the present invention.

FIG. 7 is a flowchart of a report cycle switch processing depending on a network load according to a second embodiment of the present invention.

FIG. 8 is an initial parameter storage table according to the second embodiment of the present invention.

FIG. 9 is a flowchart of a report cycle switch processing depending on apparatus failure detection according to a third embodiment of the present invention.

FIG. 10 is a failure type-based data type definition table according to the third embodiment of the present invention.

### DESCRIPTION OF EMBODIMENTS

### First Embodiment

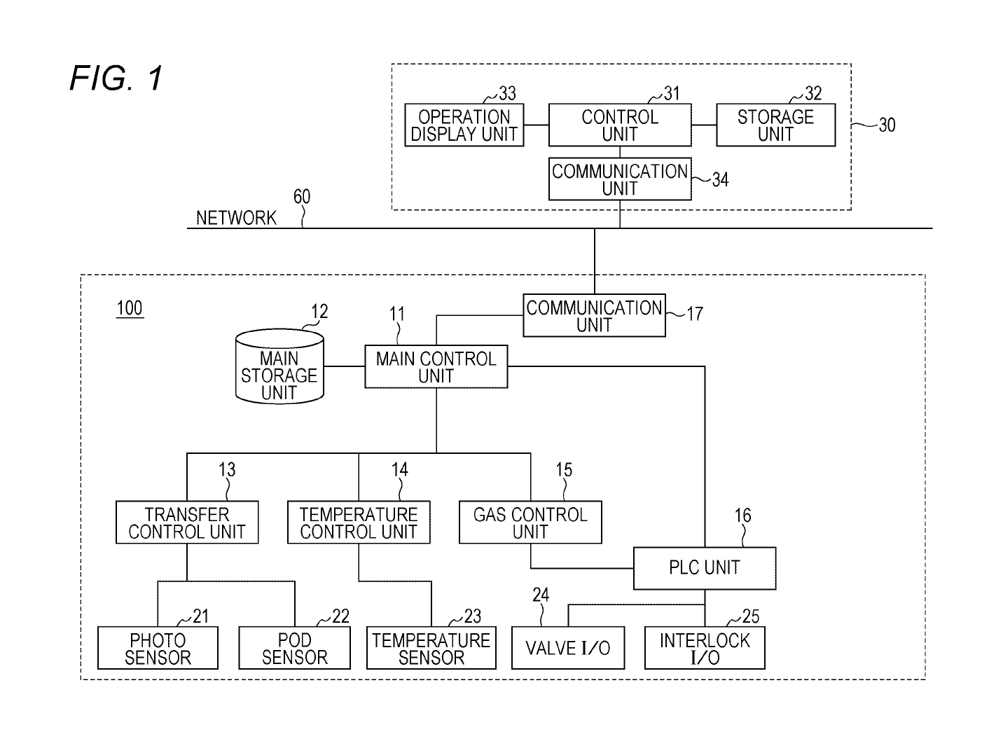

A structure of a substrate processing system according to a first embodiment of the present invention, and a structure of a substrate processing apparatus and a collective management apparatus will be described below with reference to the drawings. FIG. 1 illustrates an exemplary structure of the substrate processing system according to the first embodiment and an exemplary structure of a control system in the substrate processing apparatus and the collective management apparatus. As illustrated in FIG. 1, the substrate processing system according to the first embodiment includes a substrate processing apparatus 100, a collective management apparatus 30, and a network 60 such as in-plant LAN connecting the substrate processing apparatus 100 and the collective management apparatus 30. A plurality of, such as several tens of, substrate processing apparatuses 100 are connected to one collective management apparatus 30.

Various items of apparatus data such as processing temperature or processing chamber inside pressure generated and caused in the substrate processing apparatus 100 are stored in the substrate processing apparatus 100, and are transmitted to the collective management apparatus 30 as a higher apparatus at a predetermined cycle via the network 60. The collective management apparatus 30 stores the apparatus data received from the substrate processing apparatuses 100 in its database (storage unit 32), and effectively uses the same for failure analysis on failure occurrence and the like. In this way, the collective management apparatus 30 may be a storage device.

At first, the collective management apparatus as a higher management apparatus will be described with reference to FIG. 1. As illustrated in FIG. 1, the collective management apparatus 30 includes a control unit 31, the storage unit 32, an operation display unit 33, and a communication unit 34. The operation display unit 33 includes an operation unit for receiving an operator's instruction, and a display unit for displaying an operation screen or various items of data. The control unit 31 is electrically connected to the components such as the operation display unit 33 configuring the collective management apparatus 30, and the components are controlled by the control unit 31. The main control unit 31 includes a CPU (Central Processing Unit) and a memory for storing an operating program and the like of the control unit 31 in a hardware structure, and the CPU operates according to the operating program. The communication unit 34 exchanges various items of data with the substrate processing apparatuses 100 via the network 60.

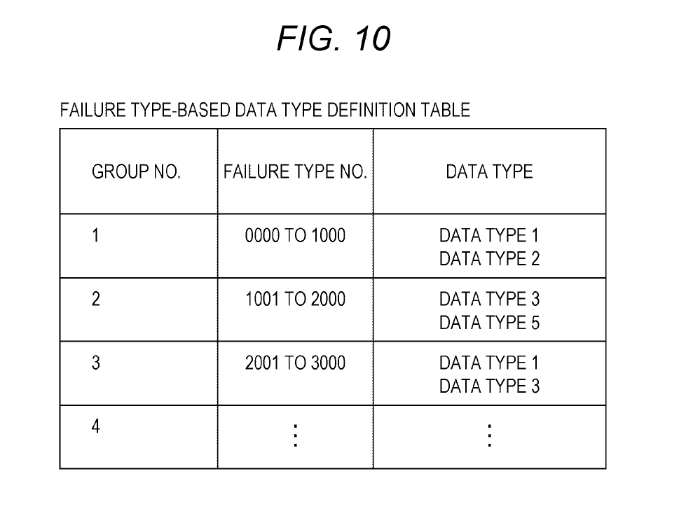

The storage unit 32 stores various items of apparatus data on the substrate processing apparatuses 100 received from the substrate processing apparatuses 100 via the network 60, and is configured of a non-volatile storage device such as hard disk or semiconductor memory. The storage unit 32 stores therein a data type-based report cycle used in the substrate processing apparatus 100, an initial parameter storage table described later (FIG. 8), a failure type-based data type definition table (FIG. 10), and the like. When, for example, the substrate processing apparatus 100 is powered on to be activated from the initial status, the collective management apparatus 30 transmits the data type-based report cycle to the substrate processing apparatus 100.

The apparatus data such as temperature, gas flow rate and pressure data of a processing furnace 202 accumulated and stored in the storage unit 32 is transferred to an analysis application apparatus (not illustrated) having a sophisticated application function as needed, and is used for the data processings for monitoring the substrate processing apparatus 100, such as statistical analysis or multivariate analysis. The analysis application apparatus can be configured of a personal computer or the like connected to the network 60.

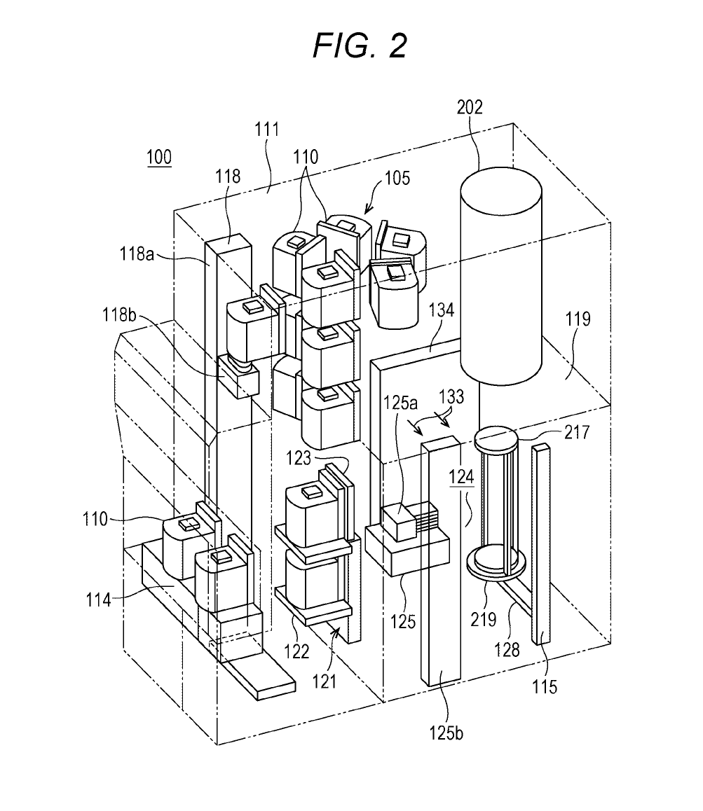

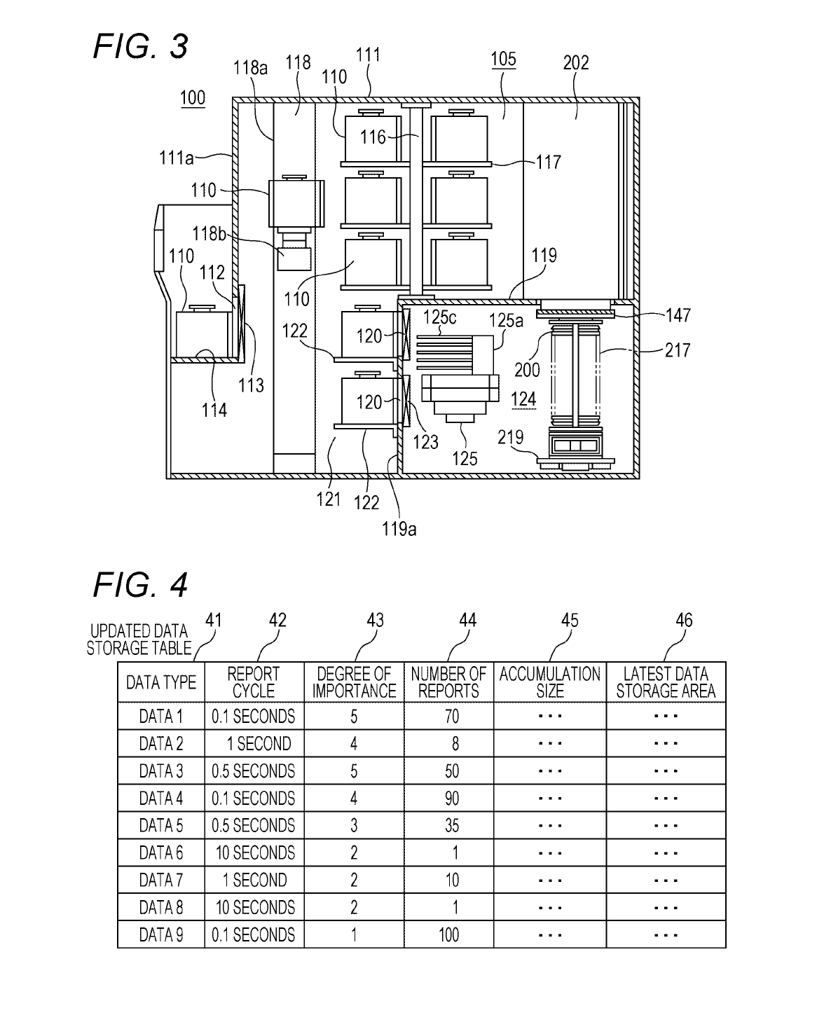

An entire structure of the substrate processing apparatus 100 will be described below with reference to FIG. 2. In the present embodiment, the substrate processing apparatus is configured as a semiconductor manufacturing apparatus for performing the processing steps in a semiconductor device (IC: Integrated Circuit) manufacturing method by way of example. There will be described below a case in which a batch-type vertical semiconductor manufacturing apparatus (which will be simply denoted as processing apparatus below) for performing an oxidation processing, a diffusion processing, a CVD (chemical vapor deposition) processing, and the like is applied as the substrate processing apparatus. FIG. 2 is a perspective view of the processing apparatus according to the first embodiment. FIG. 3 is a side perspective view of the processing apparatus illustrated in FIG. 2

As illustrated in FIG. 3, the processing apparatus 100 according to the present embodiment uses a pod 110 as a wafer carrier for housing a wafer (substrate) 200 made of silicon or the like, and includes a case 111. A pod transfer port 112 is installed on a frontal wall 111a of the case 111 to communicate inside and outside the case 111, and the pod transfer port 112 is opened and closed by a front shutter 113. A load port 114 is installed in a frontal side of the pod transfer port 112, and the load port 114 places the pod 110. The pod 110 is loaded onto the load port 114 and is unloaded from the load port 114 by an operation transfer device (not illustrated).

A rotating shelf 105 is installed above substantially a center portion in a longitudinal direction in the case 111, and the rotating shelf 105 rotates about a support 116 to store a plurality of pods 110 on a shelf board 117. As illustrated in FIG. 3, a pod transfer device 118 is installed between the load port 114 and the rotating shelf 105 in the case 111. The pod transfer device 118 is configured of a pod elevator 118a capable of going up and down while holding the pods 110 and a pod transfer mechanism 118b as a horizontal transfer mechanism, and transfers the pods 110 between the load port 114, the rotating shelf 105, and a pod opener 121.

As illustrated in FIG. 3, a sub case 119 is constructed at a rear end below substantially the center portion in the longitudinal direction in the case 111. A pair of wafer transfer ports 120 for loading and unloading the wafers 200 into and from the sub case 119 is installed in a frontal wall 119a of the sub case 119 to be vertically arranged in two stages, and a pair of pod openers 121, 121 is installed for the upper and lower wafer transfer ports 120, 120, respectively. The pod opener 121 includes placing boards 122, 122 for placing the pods 110 thereon, and cap detaching mechanisms 123, 123 for attaching and detaching a cap (lid) of the pod 110. The pod opener 121 attaches or detaches the cap of the pod 110 placed on the placing board 122 by the cap detaching mechanism 123 thereby to open or close the wafer transfer port of the pod 110. The placing board 122 is a movable shelf on which a substrate accommodating unit is placed when the substrate is transferred thereon.

As illustrated in FIG. 3, the sub case 119 configures a transfer chamber 124 isolated from an atmosphere of an installation space of the pod transfer device 118 and the rotating shelf 105. A wafer transfer mechanism 125 is installed in a front side of the transfer chamber 124. The wafer transfer mechanism 125 is configured of a wafer transfer device 125a capable of rotating or moving in a horizontal direction by placing the wafer 200 in tweezers 125c, and a wafer transfer device elevator 125b for moving the wafer transfer device 125a up and down. The wafer 200 is loaded into and unloaded from a boat 217 by a continuous operation of the wafer transfer device elevator 125b and the wafer transfer device 125a.

As illustrated in FIG. 2, a clean unit 134 configured of a supply fan and a dust proof filter is installed to supply clean air 133 as clean atmosphere or inert gas into the transfer chamber 124. As illustrated in FIG. 3, the processing furnace 202 is provided above the boat 217. The processing furnace 202 includes a substrate processing chamber (not illustrated) therein, and includes a heater (not illustrated) for heating the inside of the substrate processing chamber around the substrate processing chamber. A lower end of the processing furnace 202 is opened and closed by a furnace gate valve 147.

As illustrated in FIG. 2, a boat elevator 115 for moving the boat 217 up and down is installed. A seal cap 219 is horizontally installed in an arm 128 coupled to the boat elevator 115, and the seal cap 219 is configured to vertically support the boat 217 and to seal the lower end of the processing furnace 202. The boat 217 includes a plurality of holding members, and is configured to horizontally hold a plurality of (for example, about 50 to 125) wafers 200 vertically aligned in center.

The operations of the processing apparatus according to the present embodiment will be described below. As illustrated in FIG. 2 and FIG. 3, when the pod 110 is supplied to the load port 114, the pod transfer port 112 is opened by the front shutter 113 and the pod 110 is loaded from the pod transfer port 112. The loaded pod 110 is automatically transferred and delivered to a designated shelf board 117 of the rotating shelf 105 by the pod transfer device 118.

After being temporarily stored in the rotating shelf 105, the pod 110 is transferred from the shelf board 117 to one pod opener 121 to be transferred to the placing board 122, or is directly transferred from the load port 114 to the pod opener 121 to be transferred to the placing board 122. At this time, the wafer transfer port 120 of the pod opener 121 is closed by the cap detaching mechanism 123, and the clean air 133 is circulated and filled in the transfer chamber 124.

As illustrated in FIG. 3, the cap of the pod 110 placed on the placing board 122 is removed by the cap detaching mechanism 123, and the wafer transfer port of the pod 110 is opened. Further, the wafer 200 is picked up from the pod 110 by the wafer transfer device 125a, and is transferred and filled in the boat 217. The wafer transfer device 125a delivering the wafer 200 to the boat 217 returns to the pod 110 and loads a next wafer 110 into the boat 217.

While the wafer transfer device 125a is loading the wafer 200 into the boat 217 in one (upper or lower) pod opener 121, another pod 110 is transferred from the rotating shelf 105 or the load port 114 to the other (lower or upper) pod opener 121 by the pod transfer device 118, and an operation of opening the pod 110 by the pod opener 121 is simultaneously performed.

When a predetermined number of wafers 200 are loaded into the boat 217, the lower end of the processing furnace 202 is opened by the furnace gate valve 147. Subsequently, the seal cap 219 is moved up by the boat elevator 115, and the boat 217 supported by the seal cap 219 is loaded into the substrate processing chamber inside the processing furnace 202.

After the loading, any processing is performed on the wafer 200 in the substrate processing chamber. After the processing, the boat 217 exits by the boat elevator 115, and then the wafer 200 and the pod 110 exit to the outside of the case 111 in the reverse order of the above procedure.

A structure of a control system in the substrate processing apparatus 100 will be described below with reference to FIG. 1. As illustrated in FIG. 1, a main control unit 11 in the substrate processing apparatus 100 is electrically connected with a main storage unit 12, a transfer control unit 13, a temperature control unit 14, a gas control unit 15, a PLC (Programmable Logic Controller) unit 16, a communication unit 17, an operation unit (not illustrated) for receiving instructions of an operator, a display unit (not illustrated) for displaying an operation screen or various items of data, and the like. The communication unit 17 exchanges various items of data with the collective management apparatus 30 via the network 60.

The transfer control unit 13 is directed for controlling the positions of the pod transfer device 118, the wafer transfer mechanism 125, the boat elevator 115 and the like, and the transfer control unit 13 is electrically connected to a photo sensor 21 and a pod sensor 22, and receives data on the presence or position of a pod 110 housing a wafer 200 from the sensors, and transmits the data to the main control unit 11. The transfer control unit 13 receives an instruction to transfer a pod 110 from the main control unit 11, for example, and transfers the pod 110 to the instructed place or position.

The temperature control unit 14 is directed to control a temperature of the heater for heating the reaction furnace 202, receives temperature data from a temperature sensor 23 for measuring a temperature inside the processing furnace 202, and transmits it to the main control unit 11. The temperature control unit 14 receives from the main control unit 11 an instruction to increase a temperature inside the processing furnace 202, for example, thereby to heat the heater at the instructed temperature.

The gas control unit 15 transmits data received from a valve I/O 24 or an interlock I/O 25 to the main control unit 11 via the PLC unit 16, and transmits data received from the main control unit 11 to the valve I/O 24 or the interlock I/O 25, for example. Specifically, for example, it receives gas flow rate data from a MFC (mass flow controller) provided in a processing gas supply pipe for supply processing gas into the processing furnace 202, and transmits the same to the main control unit 11. Further, it receives a gas control instruction such as valve open/close instruction or pump drive instruction to an open/close valve provided in the processing gas supply pipe, or a pressure adjustment valve, pomp or the like provided in a processing gas exhaust pipe for exhausting gas from the processing furnace 202, and performs gas control according to the instruction. The PLC unit 16 may transmit the data received from the valve I/O 24 or the interlock I/O 25 to the main control unit 11, and may transmit the data received from the main control unit 11 to the valve I/O 24 or the interlock I/O 25.

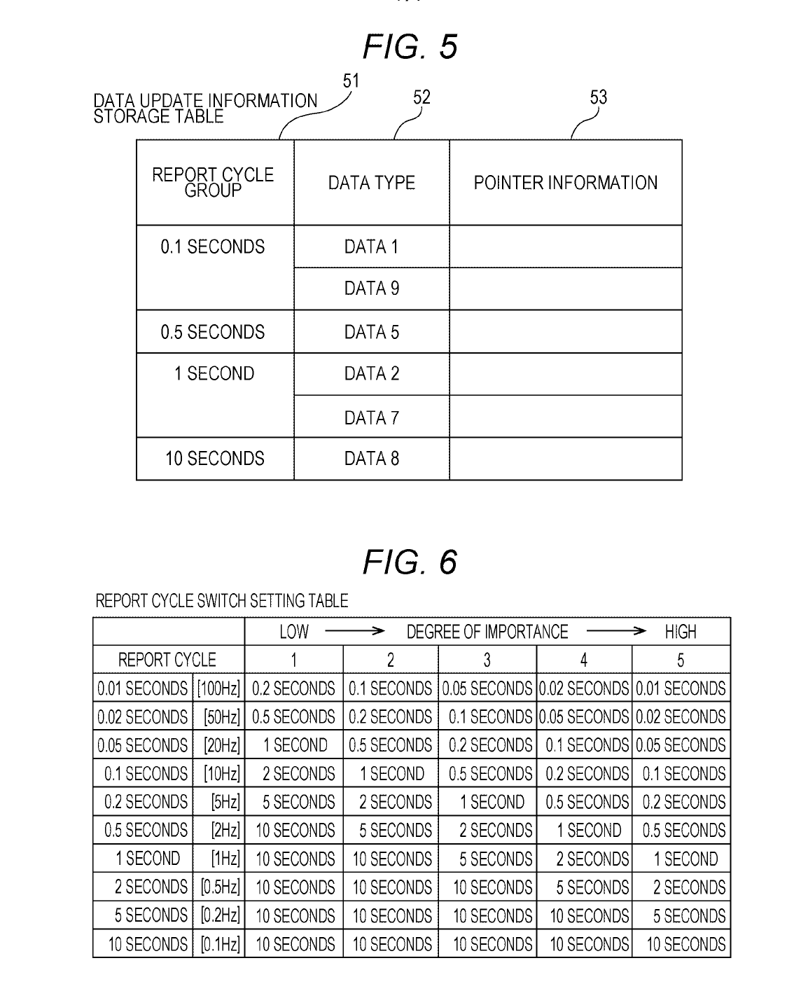

The main storage unit 12 stores a processing recipe as a substrate processing sequence of the substrate processing apparatus 100, and is configured of a non-volatile storage device such as hard disk or semiconductor memory. The main storage unit 12 stores therein an updated data storage table (see FIG. 4), a data update information storage table (see FIG. 5), a report cycle switch setting table (see FIG. 6), and the like described later.

The main control unit 11 includes a CPU (Central Processing Unit), and a memory for storing an operating program of the main control unit 11 and the like therein in a hardware structure, and the CPU operates to read and execute the processing recipe stored in the main storage unit 12 according to the operating program. Sub control units such as the transfer control unit 13, the temperature control unit 14 and the gas control unit 15 each include a CPU and a memory for storing an operating program and the like of each control unit, and each CPU operates according to the corresponding operating program.

The main control unit 11 collects monitored data such as a temperature indicated by the temperature sensor or a position of an actuator from each subcontrol unit such as the transfer control unit 13 or each component such as the PLC unit 16, and uses the monitored data to control each component to set a parameter such as temperature or pressure of the processing furnace 202 at a preset target value. A status of the pod sensor 22 or the temperature sensor 23 is transmitted to the main control unit 11 in an analog signal from each subcontrol unit or a digital signal such as RS-232C or DeviceNet. When collecting the monitored data from each component, the main control unit 11 marks a timestamp as a detection time of the collected data on the collected data, stores the marked data in the main storage unit 12, and transmits and reports the data to the collective management apparatus 30 at a predetermined cycle.

A method for determining a report cycle to the collective management apparatus 30 in the substrate processing apparatus 100 according to the first embodiment will be described with reference to FIG. 4 to FIG. 6. The report cycle determination operation is controlled by the main control unit 11 by executing a predetermined operating program (data report program). FIG. 4 is an updated data storage table according to the first embodiment of the present invention. FIG. 5 is a data update information storage table according to the first embodiment of the present invention. FIG. 6 is a report cycle switch setting table according to the first embodiment of the present invention. The main control unit 11 executes the data report program to read the updated data storage table, the data update information storage table and the report cycle switch setting table and to determine a report cycle of each item of data. At first, when the apparatus data is updated inside the substrate processing apparatus 100, for example, when the temperature data is updated in the processing furnace 202, the latest apparatus data is stored in a latest data storage area 46 per data type of the latest data in the updated data storage table illustrated in FIG. 4. For example, data 1 is stored in the latest data storage area 46 for data 1. A pointer of the latest apparatus data stored in the latest data storage area 46 is stored in a pointer information area 53 corresponding to the data type in the data update information storage table illustrated in FIG. 5. For example, for data 1, the pointer of the latest apparatus data stored in the latest data storage area 46 is stored in the pointer information area 53 for data 1. By doing so, when a data report cycle of the data type comes around, the latest apparatus data stored in the latest data storage area 46 is read to be transmitted to the collective management apparatus 30 based on the pointer stored in the pointer area 53 in the data update information table.

As illustrated in FIG. 4, the updated data storage table includes report cycle 42 to the collective management apparatus 30, degree of importance 43 of a data type 41, the number of reports 44 to the collective management apparatus 30, accumulation size of reported data 45 to the collective management apparatus 30, and the latest data storage area 46 for storing the latest apparatus data updated in the substrate processing apparatus 100 in correspondence to each data type 41.

The data type 41 is directed for mutually identifying apparatus data generated in the substrate processing apparatus 100 such as temperature data in the processing furnace 202, and may use the name or identifier (ID) of the apparatus data, for example. The example in FIG. 4 illustrates data 1 to data 9, but is not limited thereto. The report cycle 42 is a report cycle to the collective management apparatus 30, and for example, data 1 is reported to the collective management apparatus 30 every 0.1 seconds. Typically, the report cycle 42 is longer than the update cycle of the apparatus data in the substrate processing apparatus 100. As described above, when starting up and beginning to communicate with the collective management apparatus 30, the substrate processing apparatus 100 receives and acquires the report cycle 42 from the collective management apparatus 30.

The degree of importance 43 indicates a degree of importance of the data type 41, and is used for switching a report cycle described later. When starting up and beginning to communicate with the collective management apparatus 30, the substrate processing apparatus 100 receives and acquires the degree of importance 43 from the collective management apparatus 30. The report cycle 42 and the degree of importance 43 may be configured to be transmitted only for necessary data types, not being transmitted from the collective management apparatus 30 for all the data types. The default values preset in the substrate processing apparatus 100 are used for non-transmitted data types.

The number of reports 44 is the number of times to report data of the data type 41 to the collective management apparatus 30 after the substrate processing apparatus 100 starts up and begins to communicate with the collective management apparatus 30. The accumulation size 45 is a size of accumulated data of the data type 41 reported to the collective management apparatus 30 after the substrate processing apparatus 100 starts up and begins to communicate with the collective management apparatus 30. The accumulation size 45 can be handled as a size of accumulated data of the data type 41 reported to the collective management apparatus 30 for latest 1 second, and is handled in this way in the present embodiment.

Whenever apparatus data occurs in the substrate processing apparatus 100, the apparatus data is stored in the latest data storage area 46 corresponding to the data type in the substrate processing apparatus 100. The number of reports 44 and the accumulation size 45 are updated every report from the substrate processing apparatus 100 to the collective management apparatus 30.

In the present embodiment, the substrate processing apparatus 100 previously acquires an unused data size per second of the storage unit 32 in the collective management apparatus 30, and stores it in the storage unit 12. The collective management apparatus 30 is set such that the apparatus data of the substrate processing apparatus 100 to be accumulated in the storage unit 32 is stored for 90 days, for example. Therefore, an unused data size per second of the storage unit 32 in the collective management apparatus 30 can be calculated based on a possible apparatus data accumulation size per substrate processing apparatus and the predetermined storage period in the collective management apparatus 30. For example, when the possible apparatus data accumulation size per a substrate processing apparatus is 70 (G bytes) and the predetermined storage period is 90 days, the unused data size per second is 70 (G bytes)÷(90 days×24 hours×3600 seconds)≈9 (k bytes/second). That is, when each substrate processing apparatus 100 transmits about 9 (k bytes) or less of data per second to the collective management apparatus 30, a database overflow does not occur in the collective management apparatus 30.

In the present embodiment, in the substrate processing apparatus 100 which transmits over about 9 (k bytes) of data per second in the above example, or more data than the unused data size per second of the storage unit 32 in the collective management apparatus 30 to the collective management apparatus 30, the report cycle to the collective management apparatus 30 is changed to be longer. Thereby, a database overflow is prevented from occurring in the collective management apparatus 30.

As illustrated in FIG. 5, the data update information storage table stores therein report cycle group 51, data type 52 belonging to the report cycle group 51, and the pointer information 53 indicating a pointer area of the latest data storage area 46 corresponding to the data type 52 in an associated manner. For the information in the data update information storage table in FIG. 5, whenever the apparatus information of the substrate processing apparatus 100 is stored in the latest data storage area 46, the report cycle corresponding to the data type of the stored apparatus information is acquired from the updated data storage table (see FIG. 4), a determination is made as to whether the data type of the apparatus information stored in the latest data storage area 46 has been already registered in the report cycle group 51 matching with the report cycle, when registered, the information in the pointer information 53 is updated to the pointer of the apparatus information stored in the latest data storage area 46, when not registered, a data type is newly registered, and the pointer of the apparatus information stored in the latest data storage area 46 is further registered as the information in the pointer information 53.

### First Example

Next a first example according to the first embodiment of changing a report cycle to the collective management apparatus 30 will be described. In the first example, when changing a report cycle of apparatus data, the substrate processing apparatus 100 determines a data type the report cycle of which is to be changed based on the number of reports of the apparatus data stored in the storage unit 12, thereby changing the report cycle. Specifically, for a data type with the largest number of reports, the report cycle is changed to be longer. As described above, the number of reports is the number of times to report to the collective management apparatus 30 after the substrate processing apparatus 100 starts up and begins to communicate with the collective management apparatus 30.

With reference to the number of reports in the updated data storage table illustrated in FIG. 4 for each data type, data 9 is at the largest number of 100, and thus data 9 with the largest number of reports is to be changed in its report cycle. Therefore, the report cycle of data 9 is changed from 0.1 seconds to the next shortest report cycle of 0.5 seconds. Accordingly, data 9 in the updated data storage table (see FIG. 4) and the data update information storage table (FIG. 5) is switched into a report cycle group (0.5 seconds).

The report cycle is changed to be the longest (10 seconds in the example of FIG. 4) for the data type with the largest number of reports, and then the data type with the second largest number of reports (data 4 in the example of FIG. 4) is changed to be longer in its report cycle. In the first example, a data type with the shortest report cycle may be changed to be longer in its report cycle by use of the report cycle instead of the number of reports.

### Second Example

Next a second example according to the first embodiment of changing a report cycle to the collective management apparatus 30 will be described. In the second example, when changing a report cycle of apparatus data, the substrate processing apparatus 100 determines a data type the report cycle of which is to be changed based on the numbers of reports of the apparatus data and the degrees of importance stored in the storage unit 12. More specifically, for a data type the report cycle of which is to be changed extracted in the first example, the report cycle is changed to be longer depending on the degree of importance. The changed report cycle is acquired from the report cycle switch setting table illustrated in FIG. 6. In the report cycle switch setting table, the report cycles changed depending on the degrees of importance are set per report cycle. The degree of importance is classified in 5 ranks in the example of FIG. 6, where data with the highest degree of importance is indicated as degree of importance 5 and data with the lowest degree of importance is indicated as degree of importance 1. In the example of FIG. 6, the report cycles of the data types set at the degree of importance 5 are not changed.

For example, for a report cycle of 0.01 seconds (100 Hz), the changed report cycles are 0.2 seconds at the lowest degree of importance 1, 0.1 seconds at the second lowest degree of importance 2, 0.05 seconds at the third lowest degree of importance 3, 0.02 seconds at the fourth lowest degree of importance 4, and 0.01 second at the highest degree of importance 5. In this way, a changed report cycle is shorter at a higher degree of importance, and the report cycle is not changed at the highest degree of importance 5.

As described in the first example, when the report cycle of data 9 having a data type with the largest number of reports is to be changed, the report cycle information (0.1 seconds) of data 9 is acquired from the updated data storage table (FIG. 4), and the changed report cycles depending on the degrees of importance for the non-changed report cycle of 0.1 seconds are obtained in the report cycle switch setting table (FIG. 6). It is seen that data 9 has the lowest degree of importance 1, and thus the changed report cycle is 2 seconds. Therefore, the report cycle of data 9 is changed from 0.1 seconds to 2 seconds. Accordingly, the corresponding report cycles and report cycle groups in the updated data storage table (FIG. 4) and the data update information storage table (FIG. 5) are changed. In this way, a report to the collective management apparatus 30 is subsequently made at a changed report cycle.

When a report cycle needs to be changed next time, the report cycle of a data type with the largest number of reports is similarly changed to be longer depending on the degree of importance. For example, when the report cycle of data 9 is changed again, the changed report cycle with the degree of importance 1, for which the non-changed report cycle is 2 seconds, is found as 10 seconds in the report cycle switch setting table (FIG. 6). In this way, the report cycle of data 9 is changed from 2 seconds to 10 seconds. Whenever a report cycle needs to be changed, the report cycle of the data type with the largest number of reports is changed to be longer depending on the degree of importance. By repeating the processing, a report cycle to the collective management apparatus 30 can be stepwise changed to be gradually longer. In the second example, the report cycle of the data type with the shortest report cycle may be changed to be longer depending on the degree of importance by use of a report cycle instead of the number of reports.

### Third Example

Next a third example according to the first embodiment of changing a report cycle to the collective management apparatus 30 will be described. In the third example, the report cycles of data types with the lowest degree of importance are changed to be longer in ascending order of report cycle. For example, in the example of FIG. 4, a data type with the lowest degree of importance is data 9 (degree of importance 1), and thus the non-changed report cycle of 0.1 seconds of data 9 is changed to the second shortest report cycle of 0.5 seconds. Alternatively, the changed report cycle may be acquired from the report cycle switch setting table illustrated in FIG. 6 similarly to the second example.

In the third example, when a plurality of data types with the lowest degree of importance are present, a data type with the shortest report cycle or a data type with the largest number of reports is to be changed. In the third example, the report cycles of the data types with the lowest degree of importance may be changed to be longer in descending order of the number of reports. Further, a report cycle of a data type with a relatively low degree of importance may be changed to be longer irrespective of the report cycle or the number of reports.

According to the first embodiment described above, at least the following effects (1) to (6) can be obtained.

(1) Since a report cycle of apparatus data is configured to be changed based on an accumulation size of the apparatus data reported to the collective management apparatus, the amount of reported apparatus data can be accurately restricted, thereby preventing a database overflow in the collective management apparatus. (2) Since a report cycle of a data type with the largest number of reports or a data type with the shortest report cycle is configured to be changed to be longer, the amount of reported apparatus data from the substrate processing apparatus to the collective management apparatus can be restricted without excessively increasing a difference between the numbers of reports or between the report cycles per data type. (3) Since a report cycle with a low degree of importance among data types with a large number of reports or data types with a short report cycle is configured to be longer, a report cycle with a low degree of importance and a large number of reports can be automatically controlled not to be short. (4) Since a report cycle of a data type to be changed is configured to be changed to be longer depending on a degree of importance, the amount of reported important data can be restricted. (5) Since a report cycle of a data type with the highest degree of importance is configured not to be changed, a decrease in reported most important data can be restricted. (6) When a report cycle of a data type with a low degree of importance is configured to be preferentially changed, a decrease in reported important data can be more effectively restricted.

### Second Embodiment

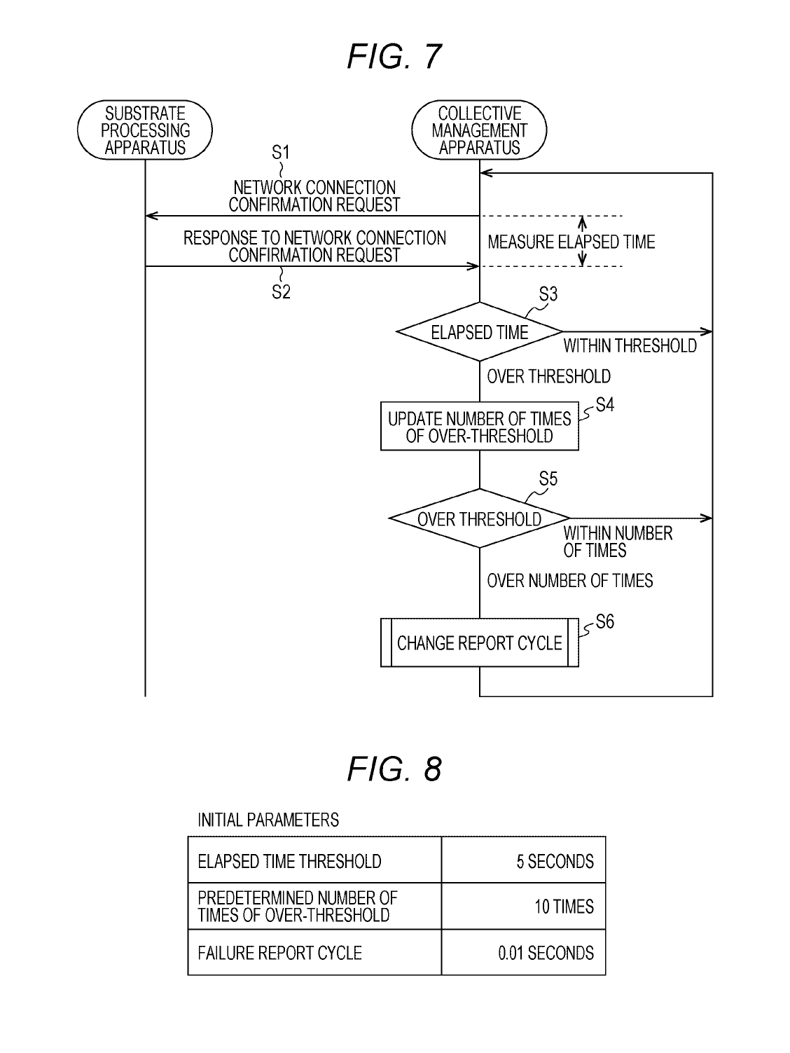

A second embodiment will be described below with reference to FIG. 7 and FIG. 8. In the second embodiment, a load status of the network 60 connecting the collective management apparatus 30 and the substrate processing apparatus 100 is monitored, and a report cycle is changed according to the load status. That is, when a load of the network 60 is higher, a report cycle from the substrate processing apparatus 100 to the collective management apparatus 30 is changed to be longer, thereby alleviating the load of the network 60. Other points are similar to the first embodiment, and thus the description thereof will be omitted.

FIG. 7 is a flow of a report cycle switch processing depending on a network load. FIG. 7 is a flowchart of the report cycle switch processing depending on a network load according to the second embodiment of the present invention. In the processing in FIG. 7, the collective management apparatus 30 and the substrate processing apparatus 100 are controlled by the control unit 31 and the main control unit 11 by executing the predetermined programs (data management programs), respectively. That is, the control unit 31 and the main control unit 11 execute the data management programs, respectively, thereby to read an updated data storage table similar to FIG. 4, a report cycle switch setting table similar to FIG. 6, and initial parameters in FIG. 8 described later and to perform the report cycle switch processing depending on a network load.

In FIG. 7, at first, when a network connection confirmation request is transmitted from the collective management apparatus 30 to the substrate processing apparatus 100 (step S1 in FIG. 7), a response to the network connection confirmation request is returned from the substrate processing apparatus 100 to the collective management apparatus 30 (step S2). After transmitting the network connection confirmation request, the collective management apparatus 30 measures an elapsed time until it receives the response to the network connection confirmation request, and when the elapsed time is within a predetermined threshold, for example, within 5 seconds (within the threshold in step S3), the collective management apparatus 30 returns to step S1 to transmit the network connection confirmation request again. When the elapsed time exceeds the predetermined threshold (over the threshold in step S3), the number of times of over-threshold in a counter provided in the storage unit 32 is updated (step S4).

When the number of times of over-threshold is within a predetermined number of times, for example, within 10 times (within the predetermined number of times in step S5), the processing returns to step S1 to transmit the network connection confirmation request again. When the number of times of over-threshold exceeds the predetermined number of times (over the predetermined number of times in step S5), an instruction to change a report cycle to be longer is made from the collective management apparatus 30 to the substrate processing apparatus 100 (step S6).

Specifically, an updated data storage table similar to FIG. 4 and a report cycle switch setting table similar to FIG. 6 are prepared in the storage unit 32 in the collective management apparatus 30, and a report cycle of a data type of data 5 is changed, for example. The updated data storage table may require only the data type 41, the report cycle 42 and the degree of importance 43, and does not require the number of reports 44, the accumulation size 45 and the latest data storage area 46. It is seen that a non-changed report cycle is 0.5 seconds and a degree of importance is 3 for data 5 from the updated data storage table (FIG. 4), and thus a changed report cycle of 2 seconds at the non-changed report cycle of 0.5 seconds and the degree of importance 3 can be obtained from the report cycle switch setting table (FIG. 6). The thus-obtained changed report cycle of 2 seconds is transmitted from the collective management apparatus 30 to the substrate processing apparatus 100 thereby to change the report cycle of data 5 for the substrate processing apparatus 100 to 2 seconds.

The elapsed time threshold and the predetermined number of times of over-threshold are previously stored as initial parameters in an initial parameter storage table in the storage unit 32 in the collective management apparatus 30. FIG. 8 is the initial parameter storage table according to the second embodiment of the present invention. In the example of FIG. 8, the elapsed time threshold and the predetermined number of times of over-threshold are set at 5 seconds and 10 times, respectively. A failure report cycle will be described according to the third embodiment.

The second embodiment is such that a load status of the network is checked in the collective management apparatus 30 and a data type to be changed and a changed report cycle are determined to be designated to the substrate processing apparatus 100, while there may be configured such that the collective management apparatus 30 simply instructs the substrate processing apparatus 100 to prolong a report cycle and the substrate processing apparatus 100 determines a data type to be changed and a changed report cycle. In this case, the initial parameter storage table in FIG. 8 is provided in the storage unit 12 in the substrate processing apparatus 100. A load status of the network is checked in the collective management apparatus 30 according to the second embodiment, but a load status of the network may be configured to be checked in the substrate processing apparatus 100. Also in this case, the initial parameter storage table in FIG. 8 is provided in the storage unit 12 in the substrate processing apparatus 100.

According to the second embodiment described above, at least the following effect (7) can be obtained. (7) Since a report cycle of apparatus data is configure to be changed depending on a load status of the network connecting the collective management apparatus and the substrate processing apparatus, a database overflow can be prevented from occurring in the collective management apparatus.

### Third Embodiment

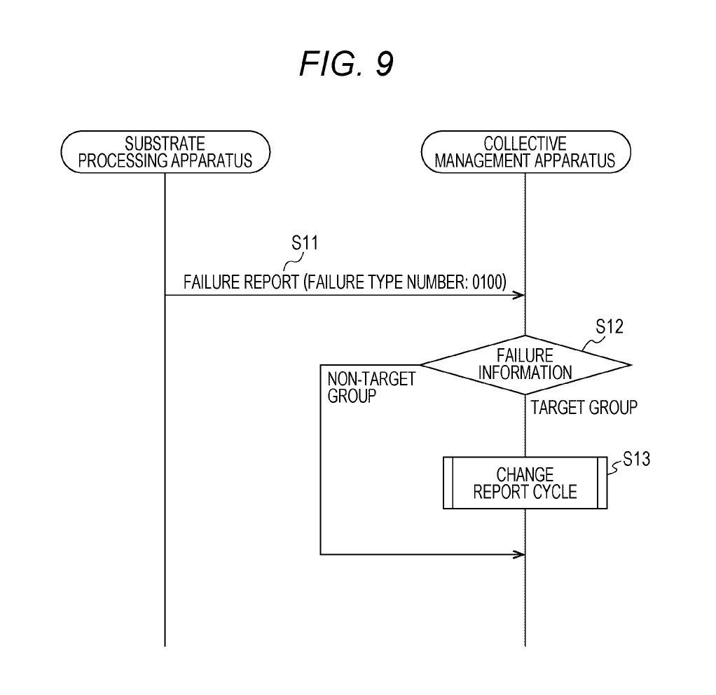

A third embodiment will be described below with reference to FIG. 9 and FIG. 10. In the third embodiment, when monitoring failures of the substrate processing apparatus 100 and receiving failure information from the substrate processing apparatus 100, the collective management apparatus 30 changes a report cycle of apparatus information on the failure information to be shorter, thereby obtaining the apparatus information with a higher accuracy. Other points are similar to the first embodiment, and thus the description thereof will be omitted.

FIG. 9 is a flow of a report cycle switch processing depending on apparatus failure detection. FIG. 9 is a flowchart of the report cycle switch processing depending on apparatus failure detection according to the third embodiment of the present invention. In the processing in FIG. 9, the collective management apparatus 30 and the substrate processing apparatus 100 are controlled by the control unit 31 and the main control unit 11 by executing the predetermined programs (failure processing programs), respectively. That is, the control unit 31 and the main control unit 11 execute the failure processing programs, respectively, to read an updated data storage table similar to FIG. 4, a report cycle switch setting table similar to FIG. 6, initial parameters similar to FIG. 8, and a failure type-based data type definition table in FIG. 10 described later and to perform the failure-based report cycle switch processing.

In FIG. 9, when a failure report with a failure type number of 0100 is made from the substrate processing apparatus 100 to the collective management apparatus 30, for example, (step S11 in FIG. 9), the collective management apparatus 30 determines whether the received failure report relates to a data type in a group the report cycle of which is to be changed with reference to the failure type-based data type definition table illustrated in FIG. 10 (step S12). In the case of a group the report cycle of which is to be changed (target group in step S12), report cycles of data types belonging to the target group are changed (step S13), and not in a group the report cycle of which is to be changed (non-target group in step S12), the report cycle is not changed and the present processing ends.

FIG. 10 is the failure type-based data type definition table according to the third embodiment of the present invention, which is previously set in the storage unit 32 in the collective management apparatus 30. The failure type-based data type definition table in FIG. 10 stores therein a failure type number of a failure report received from the substrate processing apparatus 100, and a data type the report cycle of which is to be changed in an associated manner. For example, a group No. 1 has the failure type numbers 0000 to 1000, and in this case, the report cycles of data type 1 and data type 2 are changed.

In the example of FIG. 9, since a failure report with a failure type number 0100 is made, it is seen that the report cycles of data type 1 and data type 2 are to be changed with reference to the failure type-based data type definition table (FIG. 10). In the initial parameter storage table in FIG. 8, a failure report cycle is preset at 0.01 seconds, and thus the changed report cycle of 0.01 seconds is transmitted from the collective management apparatus 30 to the substrate processing apparatus 100 to change the report cycles of data 1 and data 2 of the substrate processing apparatus 100 to 0.01 seconds. For the substrate processing apparatus 100, the report cycles of data type 1 and data type 2 are changed to 0.01 seconds in the updated data storage table (FIG. 4) and the data update information storage table (FIG. 5).

In the third embodiment, when the collective management apparatus receives failure information from the substrate processing apparatus, a report cycle of apparatus information related to the failure information is changed to be shorter in the collective management apparatus, but there may be configured such that the substrate processing apparatus stores therein the failure type-based data type definition table (FIG. 10) and the initial parameter storage table (FIG. 8), and when failure information occurs in the substrate processing apparatus, the substrate processing apparatus changes a report cycle of apparatus information related to the failure information to be shorter. In this way, the collective management apparatus does not need to store the failure type-based data type definition table (FIG. 10) or the initial parameter storage table (FIG. 8) therein. In this case, a report cycle does not need to be changed in the collective management apparatus when a failure occurs, but failure information needs to be transmitted from the substrate processing apparatus to the collective management apparatus in order to cause the collective management apparatus to recognize the failure occurrence.

According to the third embodiment described above, at least the following effect (8) can be obtained. (8) When a failure occurs in the substrate processing apparatus, a report cycle of apparatus information related to the failure information is changed to be shorter, and thus the collective management apparatus can acquire the apparatus information with a higher accuracy, thereby rapidly and easily checking a failure cause of the substrate processing apparatus.

The present invention is not limited to the above embodiments, and may be variously modified without departing from the spirit. The structures of the first to third embodiments can be configured in combination as needed. For example, the data report program executed by the main control unit 11 according to the first embodiment, and the failure processing programs executed by the main control unit 11 and the control unit 31 according to the third embodiment may be executed in parallel. The collective management apparatus does not need to be installed in the same floor as the substrate processing apparatus or a clean room, and may be installed in an office in other floor via LAN connection, for example. The collective management apparatus does not need to integrate the storage unit (database) as well as the control unit, the operation unit and the display unit, and may separately install them, and data in a database installed in a clean room may be analyzed in the operation unit or the display unit (terminal device) installed in an office. Further, the present invention is applicable to an apparatus for processing a glass substrate such as LCD manufacturing apparatus, or other substrate processing apparatuses, not only a semiconductor manufacturing apparatus. The processing contents for the substrate processings may include not only CVD, PVD, ALD, Epi and a film forming processing of forming oxide film, nitride film or metal-containing film but also annealing processing, oxidation processing, diffusion processing, etching processing, exposure processing, lithography, application processing, mold processing, development processing, dicing processing, wire-bonding processing, check processing and the like.

### Preferred Forms of the Present Invention

Preferred aspects according to the present invention will be additionally denoted below.

(Supplementary Note 1) According to one aspect of the present invention, there is provided a substrate processing system including a substrate processing apparatus for processing a substrate and generating a plurality of items of apparatus data on the substrate processing, and a management apparatus connected to the substrate processing apparatuses via a network and for receiving and storing the items of apparatus data periodically reported from the substrate processing apparatuses, wherein the substrate processing apparatus includes a control unit and a storage unit, the storage unit stores the apparatus data generated inside the substrate processing apparatus, a report cycle or the number of reports of the apparatus data to the management apparatus, and a degree of importance of the apparatus data in association with a data type of the apparatus data, and when changing a report cycle of the apparatus data, the control unit determines a data type of the report cycle of which is to be changed based on the report cycle or the number of reports and the degree of importance per data type stored in the storage unit.

(Supplementary Note 2) The substrate processing system according to supplementary note 1, wherein when a data transmission load of the network is excessively high, the management apparatus instructs the substrate processing apparatus to prolong a report cycle of the apparatus data.

(Supplementary Note 3) The substrate processing system according to supplementary note 1 or supplementary note 2, wherein when receiving failure information on failure contents in the substrate processing apparatus from the substrate processing apparatus, the management apparatus designates a data type of the report cycle of which is to be changed based on the received failure information, and instructs the substrate processing apparatus to shorten a report cycle of the apparatus data.

(Supplementary Note 4) According to another aspect of the present invention, there is provided a substrate processing apparatus for generating and periodically reporting apparatus data on a substrate processing, the substrate processing apparatus including a control unit and a storage unit, wherein the storage unit stores the apparatus data generated inside the substrate processing apparatus, a report cycle or the number of reports of the apparatus data, and a degree of importance of the apparatus data in association with a data type of the apparatus data, and when changing a report cycle of the apparatus data, the control unit determines a data type of the report cycle of which is to be changed based on the report cycle or the number of reports and the degree of importance per data type stored in the storage unit.

(Supplementary Note 5) According to still another aspect of the present invention, there is provided a data report method in a substrate processing apparatus connected to a management apparatus and directed for processing a substrate, the method including a step of generating apparatus data on a substrate processing, a step of reporting the generated apparatus data to the management apparatus, a step of storing the generated apparatus data, a report cycle or the number of reports of the apparatus data to the management apparatus, and a degree of importance of the apparatus data in association with a data type of the apparatus data, and a step of, when changing a report cycle of the apparatus data, determining a data type of the report cycle of which is to be changed based on the report cycle or the number of reports and the degree of importance stored per data type.

(Supplementary Note 6) According to still another aspect of the present invention, there is provided a storage medium capable of reading a data report program to perform a processing of reporting apparatus data on a substrate processing to a management apparatus, a processing of storing the apparatus data, a report cycle or the number of repots of the apparatus data to the management apparatus, and a degree of importance of the apparatus data in association with a data type of the apparatus data, and a data type determination processing of, when changing a report cycle of the apparatus data, determining a data type of the report cycle o which is to be changed based on the report cycle or the number of reports and the degree of importance stored per data type.

(Supplementary Note 7) According to still another aspect of the present invention, there is provided a data management method in a substrate processing system including a substrate processing apparatus for processing a substrate and a management apparatus connected to the substrate processing apparatus via a network, and for reporting apparatus data from the substrate processing apparatus to the management apparatus, the method including, for the management apparatus, a storage step of storing the apparatus data, a report cycle of the apparatus data and a degree of importance of the apparatus in association with a data type of the apparatus data, and a change instruction step of monitoring a data transmission load of the network, and when determining that the data transmission load is excessively high, determining a data type of the report cycle of which is to be changed and a report cycle based on the report cycle and the degree of importance per data type stored in the storage step, and instructing the determined data type and report cycle to be changed to the substrate processing apparatus, and for the substrate processing apparatus, a report cycle change step of, when receiving a data type and a report cycle to be changed from the management apparatus in the change instruction step, prolonging a report cycle of apparatus data of the data type based on the received data type and report cycle.

(Supplementary Note 8) According to still another aspect of the present invention, there is provided a storage medium capable of reading a data management program executed in a substrate processing system including a substrate processing apparatus for processing a substrate and a management apparatus connected to the substrate processing apparatus via a network, and for reporting apparatus data from the substrate processing apparatus to the management apparatus, the program for causing the management apparatus to perform a storage step of storing the apparatus data, a report cycle of the apparatus data, and a degree of importance of the apparatus data in association with a data type of the apparatus data, and a change instruction step of monitoring a data transmission load of the network, and when determining that the data transmission load is excessively high, determining a data type of the report cycle of which is to be changed and a report cycle based on the report cycle and the degree of importance per data type stored in the storage step, and instructing the determined data type and report cycle to be changed to the substrate processing apparatus, and for causing the substrate processing apparatus to perform a report cycle change step of, when receiving a data type and a report cycle to be changed from the management apparatus in the change instruction step, prolonging a report cycle of apparatus data of the data type based on the received data type and report cycle.

(Supplementary Note 9) According to still another aspect of the present invention, there is provide a management apparatus which is connected to a substrate processing apparatus for processing a substrate via a network and to which apparatus data on a substrate processing generated in the substrate processing apparatus is periodically reported from the substrate processing apparatus, the management device monitoring a data transmission load of the network, and when determining that the data transmission load is excessively high, instructing the substrate processing apparatus to prolong a report cycle of the apparatus data.

(Supplementary Note 10) According to still another aspect of the present invention, there is provided a failure processing method in a substrate processing system including a substrate processing apparatus for processing a substrate and a management apparatus connected to the substrate processing apparatus via a network, and for reporting apparatus data from the substrate processing apparatus to the management apparatus, wherein when receiving failure information on failure contents in the substrate processing apparatus from the substrate processing apparatus, the management apparatus performs a change instruction step of designating a data type of the report cycle of which is to be changed and a changed report cycle based on the received failure information, and making an instruction to the substrate processing apparatus, and when receiving a change instruction from the management apparatus in the change instruction step, the substrate processing apparatus performs a report cycle change step of changing a data type designated in the received change instruction to a designated report cycle.

(Supplementary Note 11) According to still another aspect of the present invention, there is provided a storage medium capable of reading a failure processing program executed in a substrate processing system including a substrate processing apparatus for processing a substrate and a management apparatus connected to the substrate processing apparatus via a network, and for reporting apparatus data from the substrate processing apparatus to the management apparatus, the program for causing the management apparatus to perform a change instruction step of, when receiving failure information on failure contents in the substrate processing apparatus from the substrate processing apparatus, designating a data type of the report cycle of which is to be changed and a changed report cycle based on the received failure information, and making an instruction to the substrate processing apparatus, and for causing the substrate processing apparatus to perform a report cycle change step of, when receiving a change instruction from the management apparatus in the change instruction step, changing a data type instructed in the received change instruction to an instructed report cycle.

(Supplementary Note 12) According to still another aspect of the present invention, there is provided a management apparatus which is connected to a substrate processing apparatus for processing a substrate and to which apparatus data on a substrate processing generated in the substrate processing apparatus is periodically reported from the substrate processing apparatus, wherein when receiving failure information on failure contents in the substrate processing apparatus from the substrate processing apparatus, the management apparatus designates a data type of the report cycle of which is to be changed and a changed report cycle based on the received failure information, and instructs the substrate processing apparatus to shorten a report cycle of the apparatus data.

(Supplementary Note 13) According to still another aspect of the present invention, there is provided a data processing method including a step of collecting apparatus data on a substrate processing, a step of storing the collected apparatus data, a report cycle or the number of reports of the apparatus data, and a degree of importance of the apparatus data in association with a data type of the apparatus data, and a data type determination step of, when changing a report cycle of the apparatus data, determining a data type of the report cycle of which is to be changed based on the report cycle or the number of reports and the degree of importance stored per data type.

(Supplementary Note 14) According to still another aspect of the present invention, there is provided a substrate processing apparatus for generating and periodically reporting apparatus data on a substrate processing, the substrate processing apparatus including a storage unit for storing the apparatus data generated inside the substrate processing apparatus, a report cycle or the number of reports of the apparatus data, and a degree of importance of the apparatus data in association with a data type of the apparatus data, and a control unit for, when changing a report cycle of the apparatus data, determining a data type of the report cycle of which is to be changed based on the report cycle or the number of reports and the degree of importance per data type stored in the storage unit.

The present application claims the priority based on Japanese Application No. 2012-150285 filed on Jul. 4, 2012, the disclosure of which is all incorporated herein by reference.

### INDUSTRIAL APPLICABILITY

The present invention is applicable to a processing system in which the amount of data between a processing apparatus for outputting monitored data such as processing temperature and processing chamber inside pressure, and a higher apparatus for collecting various items of data including the monitored data output from the processing apparatus is adjusted thereby to adjust a communication load status.
11: Main control unit, 12: Main storage unit, 13: Transfer control unit, 14: Temperature control unit, 15: Gas control unit, 16: PLC unit, 17: Communication unit, 21: Photo sensor, 22: Pod sensor, 23: temperature sensor, 24: Valve I/O, 25: Interlock I/O, 30: Collective management apparatus, 31: Control unit, 32: Storage unit, 33: Operation display unit, 34: Communication unit, 60: Network, 100: Substrate processing apparatus, 105: Rotating shelf, 110: Pod, 111: Case, 111a: Frontal wall, 112: Pod transfer port, 113: Front shutter, 114: Load port, 115: Boat elevator, 116: Support, 117: Shelf board, 118: Pod transfer device, 119: Sub case, 120: Wafer transfer port, 121: Pod opener, 122: Placing board, 123: Cap detaching mechanism, 124: Transfer chamber, 125: Wafer transfer mechanism, 128: Arm, 133: Clean air, 134: Clean unit, 142: Wafer transfer opening, 147: Furnace port shutter, 200: Wafer (substrate), 202: Processing furnace.

1. A substrate processing system comprising a substrate processing apparatus for generating apparatus data on substrate processing, and a management apparatus connected to at least one substrate processing apparatus via a network and for receiving and storing the apparatus data periodically reported from the substrate processing apparatus,
wherein the substrate processing apparatus comprises a storage unit for storing the apparatus data generated inside the substrate processing apparatus, a report cycle or the number of reports of the apparatus data to the management apparatus, and a degree of importance of the apparatus data in association with a data type of the apparatus data, and a control unit for, when changing a report cycle of the apparatus data, determining a data type of the report cycle of which is to be changed based on the report cycle or the number of reports and the degree of importance per data type stored in the storage unit.

2. The substrate processing system according to claim 1,
wherein the management apparatus instructs the substrate processing apparatus to prolong a report cycle of the apparatus data when a data transmission load of the network is excessively high.

3. A substrate processing apparatus for generating and periodically reporting apparatus data on substrate processing, the apparatus comprising a storage unit for storing the apparatus data generated inside the substrate processing apparatus, a report cycle or the number of reports of the apparatus data, and a degree of importance of the apparatus data in association with a data type of the apparatus data, and a control unit for, when changing a report cycle of the apparatus data, determining a data type of the report cycle of which is to be changed based on the report cycle or the number of reports and the degree of importance per data type stored in the storage unit.

4. A data processing method in a substrate processing apparatus comprising a storage unit for storing at least apparatus data on a substrate processing, and a control unit for periodically reporting the apparatus data,
wherein the control unit performs a step of collecting the apparatus data, a step of storing the collected apparatus data, a report cycle or the number of reports of the apparatus data, and a degree of importance of the apparatus data in association with a data type of the apparatus data, and a data type determination step of, when changing a report cycle of the apparatus data, determining a data type of the report cycle of which is to be changed based on the report cycle or the number of reports and the degree of importance stored per data type.

5. A storage medium capable of reading a data report program to perform a processing of reporting apparatus data on substrate processing to a management apparatus, a processing of storing the apparatus data, a report cycle or the number of reports of the apparatus data to the management apparatus, and a degree of importance of the apparatus data in association with a data type of the apparatus data, and a data type determination processing of, when changing a report cycle of the apparatus data, determining a data type of the report cycle of which is to be changed based on the report cycle or the number of reports and the degree of importance stored per data type.
